(19) United States
(12) Patent Application Publication
(10) Pub. No.: US 2025/0026324 A1
(43) Pub. Date: Jan. 23, 2025

(54) BRAKE SYSTEM FOR A TOWING VEHICLE

(71) Applicant: ZF CV Systems Global GmbH, Bern (CH)

(72) Inventors: Mirko Brütt, Springe (DE); Michael Haverkamp, Hannover (DE); Jan Spremberg, Wennigsen (DE)

(73) Assignee: ZF CV Systems Global GmbH, Bern (CH)

(21) Appl. No.: 18/775,436

(22) Filed: Jul. 17, 2024

(30) Foreign Application Priority Data
Jul. 21, 2023 (DE) 10 2023 206 955.5

(51) Int. Cl. B60T 8/17; B60Q 9/00; B60T 7/20; B60T 13/38; B60T 13/68; B60T 17/22

(52) U.S. Cl. CPC B60T 8/1701; B60Q 9/00; B60T 7/20; B60T 13/385; B60T 13/683; B60T 17/22; B60T 2270/402; B60T 2270/413

(57) ABSTRACT

A braking system for a towing vehicle is disclosed. The braking system includes a pressure medium source for supplying pressurized pressure medium, a parking brake module having a control valve and a redundancy valve, a trailer control valve system for a trailer brake of a trailer vehicle towed by the towing vehicle, and an electronic control unit. The electronic control unit is configured to control the trailer control valve system in such a way that pressure medium escapes via the trailer control valve system into a non-pressurized environment, whereby the pressure medium source is emptied, when the control valve or the redundancy valve persist in the open state due to a mechanical defect and otherwise should be in the closed state, and when an ignition of the towing vehicle and a compressor for filling the pressure medium source are switched off.

The invention relates to a braking system for a towing vehicle. A further claim is aimed at a method for controlling the braking system.

From EP 3 365 207 B1, a driven vehicle having a spring-applied hydraulically released (SAHR) vehicle brake is known, which comprises a first and a second brake element, which can be brought into engagement with one another, wherein the first thereof forms or is attached to a part of a rotatable element of the drive train of the vehicle and the second thereof is mounted on the vehicle in a torque-proof and movable manner, so that the first and the second element can be brought into engagement with one another and separated from one another. In this case, a mutual engagement of the brake elements causes a braking of the rotation of the rotatable element, wherein the SAHR vehicle brake (i) comprises an elastically deformable element, which acts on the second brake element in order to force the first and the second brake element into mutual engagement, and (ii) comprises a hydraulic control circuit for applying a hydraulic pressure to the second brake element, in order to counteract the effect of the elastically deformable element and thereby, in the normal case, keep the first and second brake elements separated from one another, wherein the vehicle comprises a hydraulic relief valve that can be adjusted between a one-way valve configuration, which allows the application of pressure on the second brake element and prevents pressure relief thereof, and a pressure reduction configuration, which provides a bidirectional flow of hydraulic fluid by means of the hydraulic relief valve. The hydraulic relief valve comprises a preloading element and is characterized in that the hydraulic relief valve is part of a non-electrical failure protection system of the vehicle, in which the one-way valve configuration is effective when a driving mode of the vehicle is selected and the preloading element preloads the hydraulic relief valve into the one-way valve configuration.

One problem of the present invention can be seen in providing a braking system with low hardware and software complexity. The braking system is designed to ensure that a parking lock can be engaged in the event of an unintentionally jammed valve. The problem is solved by the subject-matters of the independent claims. Advantageous embodiments are the subject-matter of the dependent claims, the following description, and the figures.

In principle, the present invention is based on the idea of reducing the pressure in the circuit of the parking brake system. In particular, a direct connection between the reservoir or the pressure medium source, the parking brake system, and the trailer control system is provided for a parking brake system. In order to support the pressure reduction of the reservoir, to react more quickly to the driver's brake request, and to avoid additional components in the interior of the towing vehicle, the present invention proposes using the trailer control valve. Additionally, or alternatively, a brake valve can also be cyclically engaged in order to control the parking brake of the towing vehicle so as to reduce the pressure in the supply line of the parking brake system. As a result, the pressure in the brake cylinders reaches a lower limit value so that the spring brake cylinders used can actuate the parking brake system.

In this sense, according to a first aspect of the invention, a braking system is provided for a towing vehicle. The braking system comprises a pressure medium source for supplying pressurized pressure medium. The pressure medium source (e.g., a tank or an accumulator) is configured so as to output the stored pressure medium in order to actuate brake cylinders of the towing vehicle and/or a trailer vehicle towed by the towing vehicle. When the ignition of the towing vehicle is switched on, a drive motor of the towing vehicle can cause a filling of the pressure medium source, e.g., by driving a compressor that intakes, compresses, and supplies air to the pressure medium source. The pressure medium can be a pneumatic pressure medium (e.g., compressed air) or a hydraulic pressure medium (e.g., oil). The braking system can therefore also be a pneumatic or hydraulic braking system. The braking system furthermore comprise a parking brake module having a control valve and, optionally, a redundancy valve. The braking system further comprises a trailer control valve system for a trailer brake of a trailer vehicle, which is towed by the towing vehicle, and an electronic control unit. In the following, the invention is described with respect to the embodiment having a control valve and the optional redundancy valve. However, the embodiments also apply mutatis mutandis for an embodiment comprising only the control valve and no redundancy valve.

The control valve and the redundancy valve are mechanically preloaded in a closed state. In normal operation, the electronic control unit is configured so as to control the control valve and the redundancy valve in such a way that they move into an open state counter to the mechanical preload. Pressure medium from the pressure medium source is thus conducted into at least one brake cylinder of the towing vehicle in order to build up a disengagement pressure in the brake cylinder, so that a parking lock of the towing vehicle is disengaged.

When the control valve or the redundancy valve are jammed in the open state and the parking lock is to be set, then the brake cylinder continues to be supplied with pressure medium so that the pressure within the brake cylinder cannot be reduced and the parking lock cannot be set. In order to counteract this critical state, it is provided according to the invention that pressure medium is discharged via the trailer control valve system into a non-pressurized environment, so that the pressure medium source is emptied in such a way that pressure medium contained therein is no longer sufficient to disengage the parking brake. In this sense, the electronic control unit is configured so as to control the trailer control valve system in such a way that pressure medium escapes via the trailer control valve system into a non-pressurized environment, whereby the pressure medium source is emptied, when the control valve or the redundancy valve persist in the open state due to a mechanical defect, although they should be in the closed state, and when an ignition of the towing vehicle and thus also a compressor for filling the pressure medium source are switched off.

In order to reduce the pressure within the pressure medium source, the electronic control unit is configured so as to control the trailer control valve system in such a way that a brake pressure output for a trailer control line, which supplies the trailer brake with pressure medium, is pressurized with interruptions. The trailer control line can furthermore be connected to the brake pressure output and to the trailer brake, wherein the electronic control unit is configured so as to control the trailer control valve system in such a way that the trailer brake is engaged and disengaged in an alternating manner in order to empty the pressure medium source via the trailer control valve system (16). When the brake pressure output for the trailer control line is pressurized, then the trailer brake is engaged so that at least one wheel of the trailer is locked. When the brake pressure output for the trailer control line is not pressurized (i.e., during one of the interruptions of the pressurization of the brake pressure output), then the trailer brake is disengaged so that the at least one wheel of the trailer is not locked.

The trailer control valve system can comprise an inlet valve, an outlet valve, and a trailer vehicle relay valve, wherein the pressure medium source is connected to the inlet valve and to the trailer vehicle relay valve. The inlet valve can be mechanically preloaded in a closed state. The inlet valve can furthermore be designed as an electromagnetically controlled proportional way valve. However, this is purely exemplary and not mandatory. Alternatively, the inlet valve can also be designed as a simple way valve, for example, which can be set to the closed state and to an open state. The outlet valve can be mechanically preloaded in an open state. The discharge valve can also be designed as an electromagnetically controlled proportional way valve. However, this is also purely exemplary and not mandatory. Alternatively, the outlet valve can also be designed as a simple way valve, for example, which can be set to the open state and to a closed state. The electronic control unit is configured in particular so as to control the inlet valve and the outlet valve in such a way that, in order to engage the trailer brake, the inlet valve is set to an open state and the outlet valve is simultaneously set to a closed state, whereby the inlet valve outputs pressure medium that is subject to a control pressure to the trailer vehicle relay valve, which, based on the control pressure, outputs pressure medium that is subject to a brake control pressure into the trailer control line for engaging the trailer brake. Alternatively, the inlet valve and the outlet valve can both be preloaded in the closed state or in the open state.

According to one embodiment, for disengaging the trailer brake, the electronic control unit is configured so as to set the inlet valve into the closed state and the outlet valve into the open state, whereby the inlet valve does not output any control pressure at the trailer vehicle relay valve, and pressure medium from the trailer control line escapes into the non-pressurized environment (U) via the trailer vehicle relay valve. The electronic control unit is configured in particular so as to cyclically repeat the engagement and disengagement of the trailer brake in order to empty the pressure medium source. The advantage of this solution is the large amount of air that is required in order to fill the trailer control line and then is sucked out again. By filling the trailer control line, in the case of a pneumatic braking system, a specific compressed air volume of the compressed air accumulator dependent on the trailer is used. The pressure in the compressed air accumulator drops due to the filling, while the air supply is simultaneously stopped (compressor switched off). Upon opening, the air from the trailer control line can be output to the non-pressurized environment via a port of the trailer control valve system.

Alternatively, the electronic control unit is configured so as to control the inlet valve and the outlet valve in such a way that the inlet valve and the outlet valve are set to the open state so that pressure medium continuously escapes from the pressure medium source via the inlet valve and via the outlet valve into the non-pressurized environment. Thus, the inlet and outlet valves are switched in such a way that both valves are in the open position. This results in a constant air leakage from the inlet to the outlet of the trailer control valve system. The advantage of such a solution is a constant, continuous pressure reduction.

The emptying of the pressure medium source via the trailer control valve system can take place without a parallel engagement and disengagement of the parking brake of the towing vehicle. In this case, it is provided that, after the complete purging of the reservoir of the parking brake system, the brake valve for the parking brake of the towing vehicle is actuated once in order to completely discharge the pressure from the spring chamber or the brake cylinder of the parking brake of the towing vehicle. This measure is necessary when the parking brake system is secured by a check valve, which secures the spring chamber against pressure losses in the storage tank due to leakages in the trailer control system. In this sense, according to a further embodiment, it is provided that the braking system comprises a check valve, which is arranged between the pressure medium source on the one hand and the brake cylinder on the other hand and prevents a flow of pressure medium from the brake cylinder in the direction of the pressure medium source. The electronic control unit is configured so as to control the brake valve in such a way that it enters into a closed state after the pressure medium source has been sufficiently emptied. In this context, the feature “sufficiently emptied” can be understood in particular to mean that pressure medium still stored in the pressure medium source is not sufficient to disengage the parking lock(s) and the trailer brake. This allows the pressure medium to escape from the brake cylinder directly into the non-pressurized environment via the brake valve until the brake cylinder has been emptied in such a way that the parking brake is engaged.

For the alternative or supplementary emptying of the pressure medium source, the electronic control unit can be configured so as to control the brake valve in such a way that it moves alternately into a closed state and into the open state when the control valve or the redundancy valve persists in the open state due to a mechanical defect, although they should be in the closed state, and when the ignition of the towing vehicle and thus also the compressor for filling the pressure medium source are switched off. When the brake valve is in the closed state, pressure medium from the brake cylinder escapes directly to the non-pressurized environment via the brake valve. Furthermore, no pressure medium is conducted from the pressure medium source into the brake cylinder. On the other hand, when the brake valve is in the open state, then pressure medium is conducted from the pressure medium source into the brake cylinder. The advantage of the above-described options for emptying the pressure medium source and the associated engagement of the parking brake of the towing vehicle in the case of a mechanically jammed control or redundancy valve is the use of existing devices that do not require additional valves or lines laid through the cabin.

In order to increase the speed of the pressure relief of larger volumes (e.g., trailer control line or spring brake cylinder), in particular in case of cyclical engagement/disengagement, the use of a quick-purge valve can be advantageous. The quick-purge valve is configured so as to discharge pressure medium from the brake cylinder and/or the trailer control line directly into the non-pressurized environment. The quick-purge valve is preferably of the feeder type. Furthermore, the quick-purge valve is arranged at least at one of the following positions, namely between a relay valve and a brake cylinder of the parking brake of the towing vehicle, within the aforementioned relay valve, within the brake cylinder and downstream of the trailer control valve system, in particular in the trailer control line connected to the trailer control valve system. Because quick-purge valves have large air passages and there is a possibility to position these valves near the pressurized volumes (brake cylinder, trainer control valve), a quick purging is possible without being restricted by small flow diameters of other valves or long lines therebetween.

Furthermore, a purely mechanical control of the braking system can be provided in normal operation. This enables a permanent pressurization of trailer brake even in the absence of the driver and thus with the ignition switched off (=unenergized state). The control valve and the redundancy valve are in the open state and output a control pressure, which is applied at the trailer vehicle relay valve. In particular, the control pressure is applied at an inverted input of the trailer vehicle relay valve, so that no pressure is output via the trailer vehicle relay valve in the direction of the trailer control line when the control pressure is applied at the inverted input of the trailer vehicle relay valve. In this sense, according to a further embodiment, it is provided that the control valve and the redundancy valve output pressure medium to the trailer vehicle relay valve when the control valve and the redundancy valve are in the open state, so that the trailer vehicle relay valve does not output any pressure medium into the trailer control line and the trailer brake is not engaged.

In addition, a warning/notification to the driver can be provided. The driver requests an engagement of the parking brake via an interface. Because one of the parking brake valves is firmly in the open position, the spring brake cylinders are still under pressure and are not engaged so that the parking lock is not tightened. At least one pressure sensor located near the spring brake cylinders detects that the pressure is not being discharged. The electronic control unit of the brake now sends a warning to the motor vehicle, which could display a warning for the driver and instructions about how to bring the vehicle into a safe state. The driver should now stop the motor vehicle with the service brake or secondary braking system engaged. At the same time, the driver is prompted to switch off the motor in order to avoid a continuous air supply to the power supply circuit of the parking brake system. As soon as the electronic control unit of the braking system recognizes that the motor is switched off via a specific terminal, the automatic emptying of the pressure medium source can be started.

In this sense, according to a second aspect of the invention, a method for controlling the braking system according to the first aspect of the invention is provided. The method comprises in particular the following steps:
(100) provision of a braking system according to the first aspect of the invention,
(200) request for engagement of the parking brake by a driver of the towing vehicle using a human-machine interface,
(300) recognition that the control valve or the redundancy valve persists in the open state due to a mechanical defect, although they should be in the closed state, by evaluating pressure values of a pressure sensor, which is arranged near the brake cylinder,
(400) outputting of a warning signal, which signals to the driver that the parking brake cannot be engaged as intended,
(500) stopping of the towing vehicle by actuating an service brake or secondary braking system,
(600) switching off of an ignition of the towing vehicle so that the compressor for filling the pressure medium source is switched off, and
(700) controlling the trailer control valve system in such a way that pressure medium escapes into the non-pressurized environment via the trailer control valve system, and/or controlling the brake valve in such a way that it moves alternately into a closed state and into the open state, whereby the pressure medium source is emptied.

When the pressure level in the spring accumulator brake chamber reaches a certain limit value that would actuate the brakes, an additional driver notification could be provided to the effect that the safe state has been reached. The driver could now release the engaged alternative braking system and exit the motor vehicle. In this sense, according to a further embodiment, it is provided that the method further comprises the following steps, namely:
(800) outputting of a safety signal, which signals to the driver that the parking brake is now engaged when the pressure medium source has been emptied such that pressure medium still stored in the pressure medium source is not sufficient for disengaging the parking brake, and
(900) stopping the actuation of the service brake or secondary braking system.

Exemplary embodiments of the invention are explained in greater detail below using the schematic drawing, wherein the same or similar elements bear the same reference numeral. The figures show:

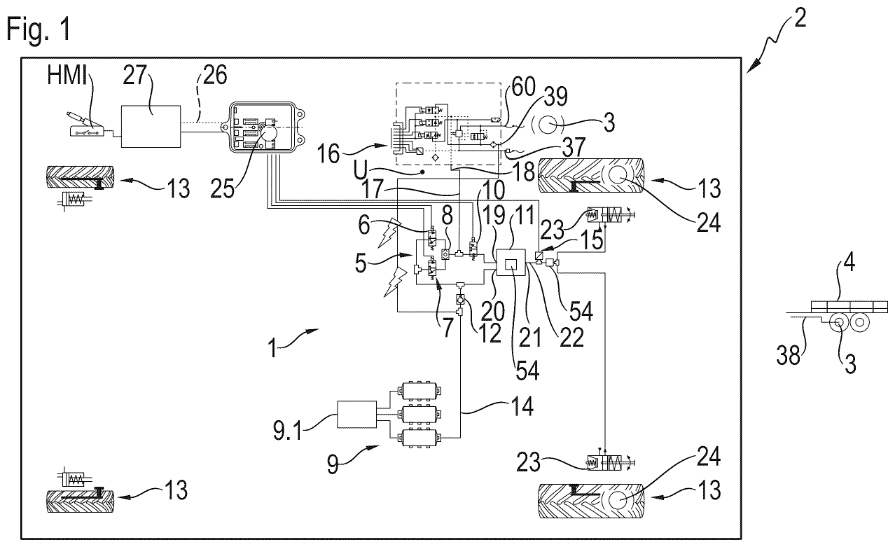

FIG. 1 is a top view of a part of a braking system for a towing vehicle and a trailer vehicle,

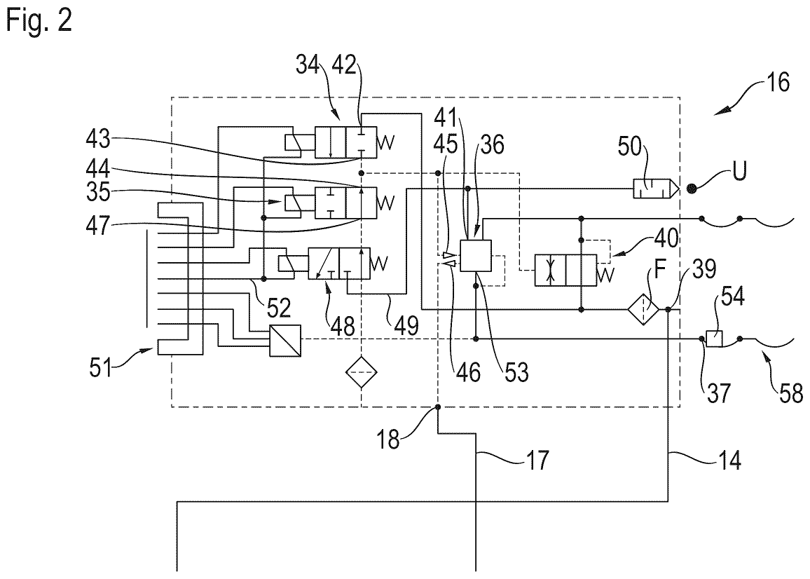

FIG. 2 is an enlarged view of a trailer control valve system of the braking system according to FIG. 1,

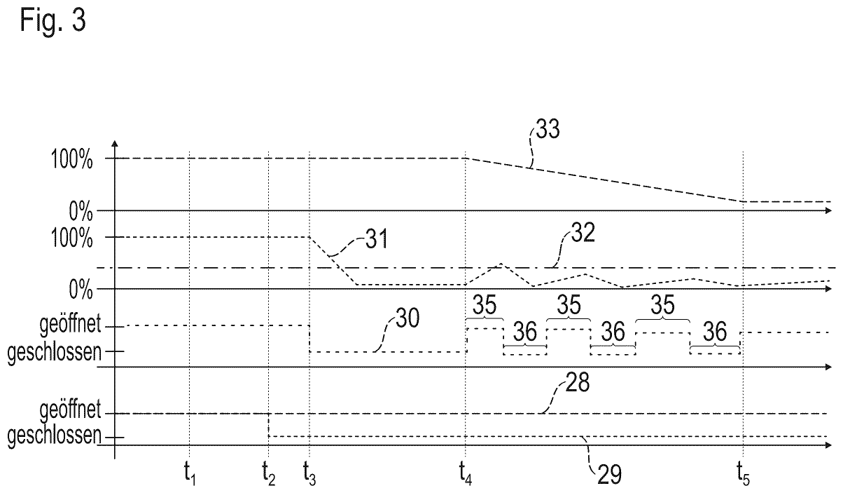

FIG. 3 illustrates exemplary state variables of the braking system according to FIG. 1.

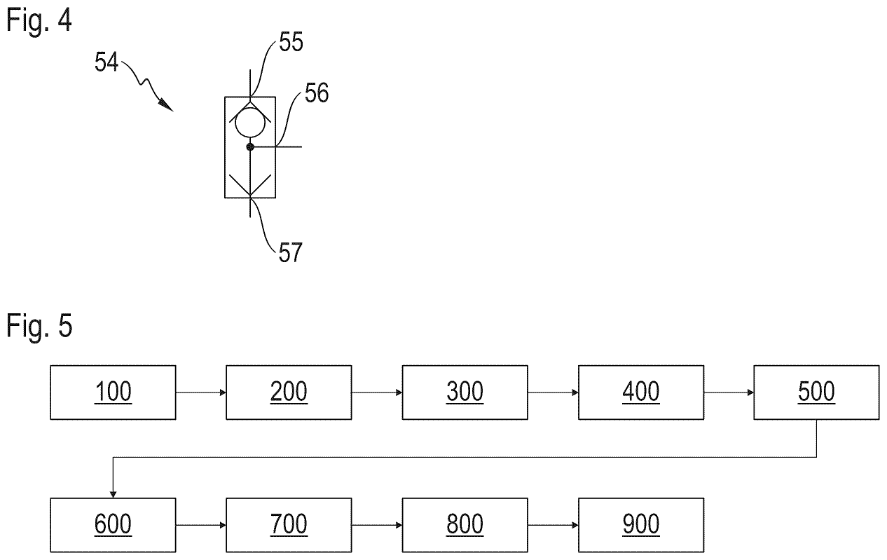

FIG. 4 illustrates exemplary details of a quick-purge valve for the braking system according to FIG. 1, and

FIG. 5 is a sequence of a method for controlling the braking system according to FIG. 1.

FIG. 1 shows a part of a braking system 1 for a towing vehicle 2 that is not further shown. The towing vehicle 2 is, for example, an agricultural commercial vehicle, in particular a tractor. The braking system 1 in particular carries out a parking brake function of wheels 13 of the towing vehicle 2 and a trailer brake 3 (merely indicated in FIG. 1) of a trailer vehicle 4. The functions described in greater detail below can be a part of a tractor-braking system platform that ensures the safe operation of the braking system 1 in various failure scenarios.

The braking system 1 comprises an electronically controllable parking brake module 5. The parking brake module 5 comprises a first 3/2-way valve designed as a control valve 6, a second 3/2-way valve designed as a redundancy valve 7, a pressure-controlled shuttle valve 8, a 3/2-way valve designed as a brake valve 10, a relay valve 11 (towing vehicle relay valve), a check valve 12, and a pressure sensor 15. The control valve 6 and the redundancy valve 7 of the parking brake module 5 are supplied on the input side via a supply line 14 and via the check valve 12 by a pressure medium source 9 with pressure medium, in the exemplary embodiment shown this is pneumatic pressure medium in the form of compressed air. The relay valve 11 of the parking brake module 5 is also supplied by the pressure medium source 9 with compressed air on the input side via the supply line 14 and via the check valve 12. The pressure medium source 9 can comprise a compressor 9.1 that can be driven by a drive machine (not shown) or by a motor (e.g., an internal combustion engine or an electric motor) of the towing vehicle 2 when an ignition of the towing vehicle 2 is switched on.

In a parallel pneumatic circuit, the control valve 6 and the redundancy valve 7 are each connected to the pressure medium source 9 on the input side via the supply line 14 and the check valve 12. The feature “connected” in particular means that the respectively connected elements are connected to one another in order to be pneumatically conductive, i.e., compressed air can flow from one element to the other element and, if necessary, vice versa. The shuttle valve 8 is respectively connected at the input side to an output of the control valve 6 and the redundancy valve 7. On the output side, the shuttle valve 8 is connected to an input of the brake valve 10 and, via a connection line 17, to a first input 18 of a trailer control valve system 16 which is described in further detail below. The respectively higher pressure of the two valves 6, 7 can thus be output via the output of the shuttle valve 8 in the direction of the brake valve 10 and the first input 18 of the trailer control valve system 16.

A control pressure input 19 of the relay valve 11 is connected to an output of the brake valve 10. A supply pressure input 20 of the relay valve 11 is connected to the pressure medium source 9 via the check valve 12 and the supply line 14. A pressure output 21 of the relay valve 11 is connected via a brake cylinder line 22 to two brake cylinders 23 for actuating one parking lock 24 each. The pressure sensor 15 is arranged in the brake cylinder line 22 and measures the pressure prevailing therein, which can likewise be considered as representative for a pressure within the brake cylinders 23. The pressure sensor 15 transmits the measured pressure to an electronic control unit 25 of the braking system 1.

In the depicted exemplary embodiment, the control valve 6 and the redundancy valve 7 are identical parts, which is however not mandatory. A valve spool of the control valve 6 and the redundancy valve 7 are each preloaded in a valve housing (not shown) by a spring element in a closed switching position (“normally closed”), which corresponds to a closed state of the control valve 6 and the redundancy valve 7 as shown in FIG. 1. When the control valve 6 and the redundancy valve 7 are in the closed state, no compressed air is conducted from the pressure medium source 9 via the control valve 6 and the redundancy valve 7 in the direction of the shuttle valve 8, the brake valve 10 arranged further downstream, and the relay valve 11 arranged further downstream. Thus, no control pressure is applied at the control pressure input 19 of the relay valve 11, as a result of which the relay valve 11 does not convey compressed air, which is applied to at supply pressure input 20, via the pressure output 21 to the brake cylinder line 22. As a result, the brake cylinders 23 are not filled with compressed air in such a way that no disengagement pressure is built up in the brake cylinders 23, thus causing the parking locks 24 to be or remain engaged.

The control valve 6 and the redundancy valve 7 have electromagnets, which can be energized in such a way that the valve spools are moved from the closed position to an open position, which corresponds to an open state of the control valve 6 and the redundancy valve 7. The electromagnet is energized by an electronic control unit 25. When the control valve 6 and the redundancy valve 7 are in the open state, compressed air is conducted from the pressure medium source 9 via the control valve 6 and the redundancy valve 7 and can be fed via the shuttle valve 8 and the brake valve 10 (arranged further downstream) to the control pressure input 19 of the relay valve 11. When the control valve 6 fails, the pressure of the redundancy valve 7 can continue to be used provided that the redundancy valve 7 has not failed. When the redundancy valve 7 fails, the pressure of the control valve 6 can continue to be used provided that the control valve 6 has not failed.

A valve spool of the brake valve 10 is preloaded inside its valve housing by a spring element in an open position shown by FIG. 1 (“normally open”), which corresponds to an open state of the brake valve 10. When the brake valve 10 is in the open state, compressed air that has been conducted from the pressure medium source 9 via the open control valve 6 or the open redundancy valve 7 as well as the shuttle valve 8 is fed via the brake valve 10 to the control pressure input 19 of the relay valve 11. In this case, the relay valve 11 conveys compressed air, which is applied at the supply pressure input 20, via the pressure output 21 to the brake cylinder line 22. Consequently, the brake cylinders 23 are filled with compressed air, which builds up a disengagement pressure in the brake cylinders 23 in such a way that the parking locks 24 are disengaged. The wheels 13 of the towing vehicle 2 are then not locked.

The electronic control unit 25 can control an energizing of an electromagnet of the brake valve 10 in such a way that the valve spool of the brake valve 10 is moved from the open position to a closed position, which corresponds to a closed state of the brake valve 10. When the brake valve 10 is in the closed state, compressed air can escape from the brake cylinders 23 via the relay valve 11 and the brake valve 10 to a non-pressurized environment U in such a way that the disengagement pressure is released and the parking lock 24 is engaged. The wheels 13 of the towing vehicle 2 are then locked. In this context, it can be said that the valve arrangement 5 has an inverting switching characteristic. The parking locks 24 of the towing vehicle 2 are engaged when no pressure is output via the relay valve 11 and are disengaged when a sufficiently high pressure is output via the relay valve 11, which results in the disengagement pressure within the brake cylinders 23.

FIG. 1 shows that the electronic control unit 25 of the braking system 1 can be connected via a CAN bus 26 to an electronic (main) control unit 27 of the towing vehicle 2. In the exemplary embodiment shown, the electronic (main) control unit 27 of the towing vehicle 2 is in particular connected to a human-machine interface HMI in an operator cab of the towing vehicle 2. Using the human-machine interface HMI, an operator or user of the towing vehicle 2 can operate the brake cylinder 23 of the towing vehicle 2 and/or the trailer brake 3 of the trailer vehicle 4. If the parking locks 24 are to be actuated or engaged in normal operation, i.e., when the electronic control unit 25 is in an engaged state, the control valve 6 and the redundancy valve 7 are disengaged, i.e., transferred to the closed state, in such a way that the brake cylinders 23 can be purged via the relay valve 11 and the disengaged brake valve 10. When the brake valve 10 is disengaged, it is in the open state in such a way that pressure medium can escape from the brake cylinder 23 via the relay valve 11, the brake valve 10, the shuttle valve 8, the control valve 6, and the redundancy valve 7 to the non-pressurized environment U.

It may be the case that the control valve 6 and/or the redundancy valve 7 have a mechanical defect, which leads to a jammed opening position of the relevant valve 6 and/or 7. In this case, the pressure inside the brake cylinders 23 cannot be discharged via the jammed valve 6 and/or 7 upon a request to actuate the parking locks 24. As long as the ignition of the towing vehicle 2 is switched on or the electronic control unit 25 for controlling the individual devices is energized, this pressure inside the brake cylinders 23 can be released by opening the brake valve 10, overcoming the constant supply from the defective valve 6 and/or 7. The electronic control unit 25 will energize the electromagnet of the brake valve 10 in such a way that its valve spool is moved into the closed position. When the valve spool of the brake valve 10 is in the closed position, the brake cylinder 23 is connected to the non-pressurized environment U via the relay valve 11 and the brake valve 10, whereas the control valve 6 and the redundancy valve 7 are disconnected from the relay valve 11 and the brake cylinders 23. As a result, compressed air escapes from the brake cylinder 23 via the brake valve 10 directly into the non-pressurized environment U. No further compressed air is conducted from the pressure medium source 9 via the relay valve 11 into the brake cylinder 23.

If the electronic control unit 25 is now also to be switched off, the electromagnet of the brake valve 10 would normally no longer be energized. This would put the brake valve 10 into the preloaded state, i.e., the valve spool of the brake valve 10 would be moved by its spring element into the open switching position shown in FIG. 1. This would pressurize the brake cylinders 23 again and release the parking locks 24. To avoid such a risky situation, the electronic control unit 25 (before it switches itself off or is allowed to be switched off) sets the brake valve 10 alternately to the open and closed state. This happens when the ignition of the towing vehicle 2 is switched off, so that the engine for driving the towing vehicle 1 and the compressor 9.1 is no longer running, as a result of which the pressure medium source 9 is no longer being filled. As a result, the brake cylinders 23 are alternately filled, pressurized, and purged again, so that the pressure medium source 9, which feeds the brake cylinders 23, is emptied in such a way that the disengagement pressure is no longer reached within the brake cylinders 23 during their filling.

FIG. 3 illustrates the scenario described above in temporal curves of state values. For example, a first graph 28 shown in FIG. 3 below shows the temporal curve of the state of the control valve 6. A further second graph 29 shown in FIG. 3 below shows the temporal curve of the state of the redundancy valve 7. Above the first and second graphs 28, 29, a third graph 30 shows the temporal curve of the state of the brake valve 10. Above the third graph 30, a fourth graph 31 shows the temporal curve of the relative pressure (0% corresponds to a non-pressurized state, 100% to a maximum permissible pressure) that prevails within the brake cylinders 23. A limit value 32 for the pressure is also shown. When the pressure prevailing inside the brake cylinders 23 is below the limit value 32, the parking locks 24 are engaged. The limit value 32 can be, for example, the disengagement pressure described above. Alternatively, a lower value can also be selected in order to prevent an increased security against unintended disengagement of the parking locks 24. Above the fourth graph 31, a fifth graph 32 shows the temporal curve of an output pressure of the pressure medium source 9.

At a first point in timepoint t₁, the towing vehicle 2 is stopped, e.g., by means of a service brake. The control valve 6, the redundancy valve 7, and the brake valve 10 remain in their open state, so that a pressure above the limit value 32 continues to prevail inside the brake cylinders 23, whereby the parking locks 24 remain disengaged. At a subsequent second timepoint t₂, the engagement of the parking locks 24 is initiated, e.g., by the driver accordingly operating the human-machine interface HMI. From the second timepoint t₂, the redundancy valve 7 is moved by its spring element from the open switching position to the closed switching position. However, this does not work with the control valve 6, because a mechanical defect ensures that the spring element of the control valve 6 cannot move its valve spool into the closed position. The control valve 6 thus persists in the open state. The brake valve 10 remains in its open state, as intended. The pressure 31 inside the brake cylinders 14 does not drop, because the control valve 6 is still open, so that compressed air from the pressure medium source 9 continues to flow unintentionally into the brake cylinders 14 via the relay valve 11.

At a subsequent third timepoint t₃, the electronic control unit 25 recognizes that the control valve 6 is in the open state, although it should be in the closed state in order to engage the parking locks 24. In order to nevertheless enable an engagement of the parking locks 24, the electronic control unit 25 energizes the electromagnet of the brake valve 10 in such a way that its valve spool moves into the closed switching position. As a result, pressure medium escapes from the brake cylinders 23 via the relay valve 11 and the brake valve 10 into the non-pressurized environment U. As a result, the pressure 31 within the pressure cylinders 14 drops below the limit value 32 and the parking locks 24 are engaged.

At a subsequent fourth timepoint t₄, the ignition of the towing vehicle 2 is switched off so that the pressure medium source 9 is no longer filled and can be emptied. The status of the ignition can be detected by the electronic control unit 25 by detecting a current that flows, or does not flow, through a corresponding terminal (“TRM15”) on the electronic control unit 27 of the towing vehicle 2. The electronic control unit 25 of the braking system 1 now energizes the electromagnet of the brake valve 10 in such a way that its valve spool moves alternately into the open and closed switching position. As a result, during an opening cycle 35 (in which the brake valve 10 is open), compressed air from the emptying pressure medium source 9 enters the brake cylinders 23 via the relay valve 11 so that pressure builds up in the brake cylinder 23. This pressure is released again in a closing cycle 36 (in which the brake valve 10 is closed) following the opening cycle 35. FIG. 3 shows that the limit value 32 is still exceeded during the first opening cycle 35 of the brake valve 10 but is no longer exceeded during the subsequent opening cycles 35.

As soon as the electronic control unit 25 recognizes that the limit value 32 is no longer reached during an opening cycle of the brake valve 10, it can switch off at a fifth timepoint t₅. In the exemplary embodiment shown in FIG. 3, the electronic control unit 25 waits for a further opening cycle before initiating its shutdown. When the electronic control unit 25 is switched off, it is in a disengaged state so that the brake valve 10 is set to its mechanically preloaded open state. The redundancy valve 7 remains in its mechanically preloaded closed state. The control valve 6 remains in its jammed open state. However, insufficient pressure medium is now fed from the at least partially emptied pressure medium source 9 via the relay valve 11 into the brake cylinders 14 in order to build up the disengagement pressure in the brake cylinders 14 and disengage the parking locks 24. In order to detect the pressure inside the brake cylinders 14, the braking system 1 comprises a pressure sensor 15. The pressure sensor 15 measures a line pressure within the brake cylinder line 22, which connects the relay valve 11 to the brake cylinders 14. The processor unit 25 accesses the line pressure measured by the pressure sensor 15 and can switch itself off as described above when the line pressure no longer reaches the specified limit value during the filling of the brake cylinders 23 (i.e., during one of the opening cycles 35 described above).

The trailer control valve system 16 can also be used in order to empty the pressure medium source 9, namely both as an alternative and in addition to the aforementioned engagement and disengagement of the parking lock 24 of the towing vehicle 2. As can be seen particularly well in FIG. 2, the trailer control valve system 16 comprises in particular an inlet valve 34, an outlet valve 35, and a trailer vehicle relay valve 36. Furthermore, a trailer control line 38 of the trailer vehicle 4 is connected on the one hand to a trailer brake port or brake pressure output 37 of the trailer control valve system 5 and on the other hand to the trailer brake 3 of the trailer vehicle 4. Furthermore, the supply line 14 is connected to a second input 39 of the trailer control valve system 16.

On the one hand, compressed air from the pressure medium source 9 flows via the supply line 14 through the second input 39 into the trailer control valve system 16 while bypassing the check valve 12, where it is fed via a filter F and a break-off valve 40 to a pressure input 41 of the towing vehicle relay valve 36. On the other hand, compressed air flows from the pressure medium source 9 via the supply line 14 through the second input 39 into the trailer control valve system 16, also while bypassing the check valve 12, where it is fed via the filter F and while bypassing the break-off valve 40 to an input 42 of the inlet valve 34. On the one hand, an output 43 of the inlet valve 34 is connected to an input 44 of the outlet valve 35. On the other hand, the output 43 of the inlet valve 34 is connected to a first control input 45 of the trailer vehicle relay valve 36. A second inverted control input 46 of the trailer vehicle relay valve 36 is connected to the first input 18 of the trailer control valve system 18. Compressed air that is output by the control valve 6 or the redundancy valve 7 can flow via the shuttle valve 8 and the connection line 17 through the first input 18 into the trailer vehicle relay valve 36, where it is fed to the second inverted control input 46. An output 47 of the outlet valve 35 can further be connected to the non-pressurized environment U via a redundancy valve 48 of the trailer control valve system 16, a discharge line 49, and a sound absorber 50.

The inlet valve 34 and the outlet valve 35 in the shown exemplary embodiment are electromagnetically controlled proportional way valves having an electromagnet that can be controlled by the electronic control unit 25 and a spring element for the mechanical preloading of a valve spool of the inlet valve 34 and the outlet valve 35. The inlet valve 34 is mechanically preloaded in a closed state as shown by FIGS. 1 and 2. The outlet valve 35 is mechanically preloaded in an open state as shown by FIGS. 1 and 2. When the inlet valve 34 is in the closed state and the outlet valve 35 is in the open state, no compressed air flows through the inlet valve 34 to the first control input 45 of the trailer vehicle relay valve 36. When compressed air, which is output by the control valve 6 or the redundancy valve 7, is additionally supplied to the second inverted control input 46 of the trailer vehicle relay valve 36, then the trailer vehicle relay valve 36 does not output any compressed air applied at the pressure inlet 41 in the direction of the brake pressure output 37 via its pressure output 53. Accordingly, no compressed air flows into the trailer control line 38, and the trailer brake 3 is not engaged, so that the wheels of the trailer vehicle 4 are not locked.

The electronic control unit 25 is connected to a power strip 51 of the trailer control valve system 16. The power strip 51 is connected via electronic control lines 52 (for the sake of clarity, only one of them bears a reference numeral in FIG. 2), in particular with the electromagnets of the inlet valve 34 and the outlet valve 35. The electronic control unit 25 can thus control the state of the inlet valve 34 and the outlet valve 35 via the power strip 51 and the electronic control lines 52. In particular, the electronic control unit 25 can move the inlet valve 34 from the closed state to an open state by energizing its electromagnet counter to the mechanical preload. Similarly, the electronic control unit 25 can move the outlet valve 35 from the open state to a closed state by energizing its electromagnet counter to the mechanical preload.

When the inlet valve 34 is in the open state and the outlet valve 35 is in the closed state, compressed air flows to the first control input 45 of the trailer vehicle relay valve 36 via the inlet valve 34. The inlet valve 34 outputs compressed air that is subject to a control pressure to the trailer vehicle relay valve 36, which outputs compressed air that is subject to a brake control pressure to the trailer brake port 37 based on the control pressure. Accordingly, compressed air flows into the trailer control line 38, and the trailer brake 3 is engaged so that the wheels of the trailer vehicle 4 are locked. Subsequently, the electronic control unit 25 can return the inlet valve 34 to the mechanically preloaded closed state by stopping the energization of its electromagnet in order to disengage the trailer brake 3. Similarly, the electronic control unit 25 can return the outlet valve 35 to the mechanically preloaded open state by stopping the energization of its electromagnet. On the one hand, this interrupts the pressurization of the brake pressure output 37 and the trailer control line 38, which supply the trailer brake 3 with compressed air. On the other hand, compressed air in the trailer control line 38 is discharged into the non-pressurized environment U via the trailer brake port 37, the trailer vehicle relay valve 36, and the sound absorber 50.

Due to the alternating engagement and disengagement of the trailer brake 3 (alternative a)) described above, in particular in the case of a control valve 6 that is mechanically jammed in the open state and/or redundancy valve 7, a volume of compressed air from the pressure medium source 9 is consumed, which contributes to emptying the pressure medium source 9. At the same time, the compressor 9.1 of the pressure medium source 9 is no longer filled when the ignition and drive engine are switched off. The engagement and disengagement of the trailer brake 3 can be repeated several times in order to contribute to the emptying of the pressure medium source 9, both as an alternative and in addition to the likewise repetitive engagement and disengagement of the parking lock 24 of the towing vehicle 2. As an alternative to the alternating engagement and disengagement of the trailer brake 3 (alternative a)), the electronic control unit 25 can control the inlet valve 34 and the outlet valve 35 in such a way that both the inlet valve 34 and the outlet valve 35 are set to the open state (alternative b)). As a result, compressed air continuously escapes from the pressure medium source 9 via the inlet valve 34, the outlet valve 35, the redundancy valve 48, the discharge line 49, and the sound absorber 50 into the non-pressurized environment U.

According to FIG. 1, the check valve 12 is arranged between the pressure medium source 9 on the one hand and the brake cylinder 23 on the other hand. The check valve 12 prevents compressed air from flowing out of the brake cylinder 23 in the direction of the pressure medium source 9. The check valve 12 secures the spring chambers of the brake cylinders 23 against pressure losses in the reservoir 9 due to leakages in the trailer control system 16. If only the trailer brake 3 is alternately engaged and disengaged in order to empty the pressure medium source 9, but not the parking lock 24 of the towing vehicle 2, when the control valve 6 or the redundancy valve 7 jams, it is provided that, after the complete purging of the pressure medium source 9 via the trailer control valve system 16, the brake valve 10 is actuated once in order to release the pressure from the spring chambers of the brake cylinders 23. For this purpose, the electronic control unit 25 controls the brake valve 10 in such a way that it enters the closed state after the pressure medium source 9 has been sufficiently emptied, as a result of which pressure medium escapes from the brake cylinder 23 via the brake valve 10 directly into the non-pressurized environment U. This is done until the brake cylinders 23 have been emptied in such a way that the parking locks 24 are engaged. In this context, the feature “after the pressure medium source 9 has been sufficiently emptied” can be understood in particular to mean that compressed air still stored in the pressure medium source 9 is not sufficient to disengage the parking locks 24 and the trailer brake 3.

In order to further increase the speed of the pressure relief of larger volumes (e.g., in the trailer control line 38 or in the spring brake cylinders 23) during cyclical engagement/disengagement, according to the exemplary embodiment according to FIG. 1, at least one quick-purge valve 54 is provided. The quick-purge valve 54 can be integrated into the relay valve 11. Alternatively, the quick-purge valve 54 can be arranged downstream of the trailer control valve system 16 or in the brake cylinder line 22 between the towing vehicle relay valve 11 and the brake cylinders 23. Furthermore, at least one of the brake cylinders 23 can be arranged in one of the quick-purge valves 54 (not shown). In the exemplary embodiment shown by FIG. 4, the at least one quick-purge valve 54 is of the feeder type and is similar to a check valve having a first port 55, a second port 56 and a third port 57. The purging of the quick-purge valve 54 is closed as long as the first port 55 is under pressure. However, as soon as the first port 55 is non-pressurized, the pressure at the second port 56 opens the passage between the second port 55 and the third port 57 (outlet) such that the output of the quick-purge valve 54 is purged.

Referring now to the arrangement of the quick-purge valve 54 downstream of the trailer control valve system 16, the first port 55 is connected to the brake pressure output 37. The second port 56 is connected to a coupling head 58 (“Yellow Coupling Head” YCH), which connects the brake pressure output 37 to the trailer control line 38. The trailer control line 38 is thus connected to the quick-purge valve 54. The third port 37 is connected to the non-pressurized environment U. Consequently, the trailer control line 38 can be purged via the third port 57 of the quick-purge valve 54, preferably via a noise or sound absorber. In a hydraulic alternative that is not shown, purging could take place in a non-pressurized tank.

Referring now to the arrangement of the quick-purge valve 54 in or downstream of the towing vehicle relay valve 11, the first port 55 is connected to the supply pressure input 20 of the towing vehicle relay valve 11. The second port 56 is connected to a T-piece 59 between the two brake cylinders 23. The two brake cylinders 23 are thus connected to the quick-purge valve 54. The third port 37 is connected to the non-pressurized environment U. Consequently, the brake cylinders can be purged via the third port 57 of the quick-purge valve 54, preferably via a noise or sound absorber. In a hydraulic alternative that is not shown, purging could take place in a non-pressurized tank.

Normally, no electronic control is required via the connection of the first input 18 and the brake pressure output 37 of the trailer control valve system 16 as described above. The idea behind this is that a permanent pressurization of trailer brake 3 is possible even in the absence of the driver and thus with the ignition switched off (=unenergized state).

According to the alternatives a) and b), a special operation mode is given, namely the parking brake request of the driver, which cannot be carried out by the jammed valve 6 or 7. The brake cylinders 23 are thus still pressurized, which is determined by the pressure sensor 15. The driver is informed of this special fault and the fact that the parking lock 24 is only engaged when the ignition is switched off and thus the compressor 9.1 no longer conveys air into the pressure medium source 9 (“air tank 3”). In this special operation mode, the electronic control unit 25 does not yet switch off, but it remains engaged. The electronic control unit 25 is now able to increase and decrease the pressure at the brake pressure output 37 via the switching of the inlet valve 34 and the outlet valve 35 of the trailer control valve system 16 and thus to reduce the pressure in the pressure medium source 9. As soon as it can then be determined via a tank pressure sensor of the pressure medium source 9 that the pressure is so low that the spring accumulators would initiate the parking locks 24, the brake valve 10 can be actuated once in order to reduce the pressure in the brake cylinders 23. However, due to the low supply pressure level, a switching off of the brake valve 10 does not lead to a new release or disengagement of the parking locks 24. Once this state is reached and confirmed by the pressure sensor 15 in front of the brake cylinders, the electronic control of the trailer control valve system 16 is ended. In this case, the pressure medium source 16 is emptied. Therefore, no further pressure can be adjusted at the brake pressure output 37, nor at a trailer supply line 60. Trailers have a trailer brake valve, which automatically goes into the brake position with the air supply stored on trailer vehicle 4 when the trailer supply line 60 (“red coupling head”) is non-pressurized.

FIG. 5 shows a sequence of a method for controlling the braking system according to FIG. 1, which is provided in a first method step 100. A warning/information of the driver is ensured by means of the method. In a second method step 200, the driver requests an engagement of the parking locks 24 via the human-machine interface HMI. Because either the control valve 6 or the redundancy valve 7 is firmly in the open position, the spring brake cylinders 23 are still under pressure and are not engaged so that the parking locks 24 are not tightened. In a third method step 300, the pressure sensor 15, which is located near the spring brake cylinders 23, recognizes that the pressure from the brake cylinders 23 is not being discharged. In a fourth method step 400, the electronic control unit 25 of the braking system 1 now sends a warning signal to the electronic (main) control unit 27 of the towing vehicle. The warning signal can be, for example, visual (text and/or image display on a user interface such as a display, a red signal light, etc.) or acoustic. The warning signal signals to the driver that the parking locks 24 cannot be engaged as intended. The warning signal can also contain instructions for the driver about how to bring the towing vehicle 2 and the trailer vehicle 4 into a safe state according to the method steps described below.

In a fifth method step 500, the driver will then bring the towing vehicle 2 together with the trailer vehicle 4 to a standstill with the service brake or secondary braking system engaged. At the same time, the driver is prompted to switch off the motor of the towing vehicle 2 in order to avoid a continuous air supply to the power supply circuit of the parking brake module 5. Consequently, the driver will switch off the ignition of the towing vehicle 2 in a sixth method step 600, so that the compressor 9.1 for filling the pressure medium source 9 is switched off. As soon as the electronic control unit 25 of the braking system 1 recognizes that the motor is switched off via terminal TRM15, the electronic control unit 25 can begin to reduce the pressure in the pressure medium source 9 and thus also in the brake cylinders 23 and in the trailer braking system 3. As described above, this is done in a seventh method step 700 in that, in particular according to alternatives a) and b), compressed air is discharged via the trailer control valve system 16 into the non-pressurized environment U. Additionally or alternatively, the parking locks 24 of the towing vehicle 1 can also be engaged and disengaged in an alternating manner.

When the pressure level in the brake cylinders 23 no longer reaches the limit value pressure 32, then an additional driver notification can be output to the effect that the safe state has been reached. In this sense, in an eighth method step 800, when the pressure medium source 9 is emptied such that pressure medium still stored in the pressure medium source 9 is not sufficient to disengage the parking lock 24, a safety signal is output, which signals to the driver that the parking locks 24 are now engaged. The driver can then release the previously engaged alternative braking system in a ninth method step (900) and exit the towing vehicle 2.

### LIST OF REFERENCE NUMERALS

F Filter
HMI Human-machine interface
TRM15 Terminal of ignition
t₁ First timepoint
t₂ Second timepoint
t₃ Third timepoint
t₄ Fourth timepoint
t₅ Fifth timepoint
U Non-pressurized environment
1 Braking system
2 Towing vehicle
3 Trailer brake
4 Trailer vehicle
5 Parking brake module
6 Control valve
7 Redundancy valve
8 Shuttle valve
9 Pressure medium source
9.1 Compressor
10 Brake valve
11 (Towing vehicle) relay valve
12 Check valve
13 Wheels
14 Supply line
15 Pressure sensor
16 Trailer control valve system
17 Connection line
18 First input of trailer control valve system
19 Control pressure input of relay valve
20 Supply pressure input of relay valve
21 Pressure output of relay valve
22 Brake cylinder line
23 Brake cylinder
24 Parking brake
25 Electronic control unit
26 CAN bus
27 Electronic (main) control unit
28 Temporal curve of the state of the control valve
29 Temporal curve of the state of the redundancy valve
30 Temporal curve of the state of the brake valve
31 Temporal curve of the brake cylinder pressure
32 Limit pressure
33 Temporal curve of the output pressure of the pressure medium source
34 Inlet valve
35 Outlet valve
36 Relay valve
37 Brake pressure output
38 Trailer control line
39 Input of trailer control valve system
40 Break-off valve
41 Pressure input of trailer vehicle relay valve
42 Input of inlet valve
43 Output of inlet valve
44 Input of outlet valve
45 First control input of trailer vehicle relay valve
46 Second inverted control input of trailer vehicle relay valve
47 Output of outlet valve
48 Redundancy valve of trailer control valve system
49 Discharge line
50 Sound absorber
51 Power strip
52 Electronic control line
53 Pressure output of trailer vehicle relay valve
54 Quick purge valve
55 First port of quick-purge valve
56 Second port of quick-purge valve
57 Third port of quick-purge valve
58 Coupling head
59 T-piece
60 Trailer supply line
100 Method step
200 Method step
300 Method step
400 Method step
500 Method step
600 Method step
700 Method step
800 Method step
900 Method step

1. A braking system (1) for a towing vehicle (2), comprising:
a pressure medium source (9) for supplying pressurized pressure medium;
a parking brake module (5) having a control valve (6) and a redundancy valve (7);
a trailer control valve system (16) for a trailer brake (3) of a trailer vehicle (4) which is towed by the towing vehicle (2); and
an electronic control unit (25), wherein
the control valve (6) and the redundancy valve (7) are mechanically preloaded in a closed state, and
the electronic control unit (25) is configured to:
control the control valve (6) and the redundancy valve (7) in such a way that (i) they can move into an open state counter to the mechanical preload, ii so that pressure medium is conducted from the pressure medium source (9) into a brake cylinder (23) of the towing vehicle (2) in order to build up a disengagement pressure in the brake cylinder (23), and (iii) so that a parking lock (24) of the towing vehicle (2) is disengaged, and
control the trailer control valve system (16) in such a way that pressure medium can escape via the trailer control valve system (16) into a non-pressurized environment (U), whereby the pressure medium source (9) is emptied when (i) the control valve (6) or the redundancy valve (7) persists in the open state due to a mechanical defect and otherwise should be in the closed state, and (ii) when an ignition of the towing vehicle (2) and thus also a compressor (9.1) for filling the pressure medium source (9) are switched off.

2. The braking system (1) according to claim 1, wherein the electronic control unit (25) is configured to control the trailer control valve system (16) in such a way that a brake pressure output (37) for a trailer control line (38), which supplies the trailer brake (3) with pressure medium, is pressurized with interruptions.

3. The braking system (1) according to claim 2, wherein
the trailer control line (38) is connected to the brake pressure output (37) and to the trailer brake (3), and
the electronic control unit (25) is configured to control the trailer control valve system (16) in such a way that the trailer brake (3) can be engaged and disengaged in an alternating manner in order to empty the pressure medium source (9) via the trailer control valve system (16).

4. The braking system (1) according to claim 3, wherein
the trailer control valve system (16) comprises an inlet valve (34), an outlet valve (35), and a trailer vehicle relay valve (36),
the pressure medium source (9) is connected to the inlet valve (34) and to the trailer vehicle relay valve (36),
the inlet valve (34) is mechanically preloaded in a closed state,
the outlet valve (35) is mechanically preloaded in an open state, and
the electronic control unit (25) is configured to control the inlet valve (34) and the outlet valve (35) in such a way that, in order to engage the trailer brake (3), the inlet valve (34) can be set to an open state and the outlet valve (35) can be simultaneously set to a closed state, whereby the inlet valve (34) outputs pressure medium that is subject to a control pressure to the trailer vehicle relay valve (36), which, based on the control pressure, outputs pressure medium that is subject to a brake control pressure into the trailer control line (38) for engaging the trailer brake (3).

5. The braking system (1) according to claim 4, wherein, for disengaging the trailer brake (3), the electronic control unit (25) is configured to set the inlet valve (34) into the closed state and the outlet valve (35) into the open state, whereby the inlet valve (34) does not output any control pressure at the trailer vehicle relay valve (36), and pressure medium from the trailer control line (38) escapes into the non-pressurized environment (U) via the trailer vehicle relay valve (36).

6. The braking system (1) according to claim 5, wherein the electronic control unit (25) is configured to cyclically repeat the engagement and disengagement of the trailer brake (3) in order to empty the pressure medium source (9).

7. The braking system (1) according to claim 1, wherein the electronic control unit (25) is configured to control the inlet valve (34) and the outlet valve (35) in such a way that the inlet valve (34) and the outlet valve (35) can be set to the open state so that pressure medium continuously escapes from the pressure medium source (9) via the inlet valve (34) and via the outlet valve (35) into the non-pressurized environment (U).

8. The braking system (1) according to claim 1, wherein the braking system (1) further comprises a check valve (12), wherein
the check valve (12) is arranged between the pressure medium source (9) and the brake cylinder (23) and is configured to prevent a flow of pressure medium from the brake cylinder (23) in the direction of the pressure medium source (9),
the electronic control unit is configured to control the brake valve (10) in such a way that the brake valve moves into a closed state after the pressure medium source (9) has been sufficiently emptied, whereby pressure medium escapes from the brake cylinder (23) via the brake valve (10) directly into the non-pressurized environment (U) until the brake cylinder (23) has been emptied such that the parking brake (24) is engaged.

9. The braking system (1) according to claim 1, wherein
for emptying the pressure medium source (9), the electronic control unit (25) is configured to control the brake valve (10) in such a way that the brake valve moves into a closed state and into the open state in an alternating manner when (i) the control valve (6) or the redundancy valve (7) persists in the open state due to a mechanical defect and otherwise should be in the closed state, and (ii) when the ignition of the towing vehicle (2) and the compressor (9.1) for filling the pressure medium source (9) are switched off.

10. The braking system (1) according to claim 9, wherein the braking system (1) further comprises a quick-purge valve (54), wherein the quick-purge valve (54) is configured to discharge pressure medium from the brake cylinder (23) and/or the trailer control line (38) directly into the non-pressurized environment (U).

11. The braking system (1) according to claim 10, wherein the control valve (6) and the redundancy valve (7) are configured to output pressure medium to the trailer vehicle relay valve (36) when the control valve (6) and the redundancy valve (7) are in the open state, so that the trailer vehicle relay valve (36) does not output any pressure medium into the trailer control line (38) and the trailer brake (3) is not engaged.

12. A method for controlling a braking system (1), wherein the method comprises the following steps:
providing (100) the braking system (1) according to claim 1;
receiving (200) a request for engagement of the parking brake (24) by a driver of the towing vehicle (2) using a human-machine interface (HMI);
recognizing (300) that the control valve (6) or the redundancy valve (7) persists in the open state due to a mechanical defect they and otherwise should be in the closed state, by evaluating pressure values of a pressure sensor (15) arranged near the brake cylinder (23);
outputting (400) a warning signal, which signals to the driver that the parking brake (24) cannot be engaged as intended;
stopping (500) of the towing vehicle (2) by actuating a service brake or a secondary braking system,
switching off (600) an ignition of the towing vehicle so that the compressor (9.1) for filling the pressure medium source (9) is switched off; and
controlling (700) the trailer control valve system in such a way that pressure medium escapes into the non-pressurized environment (U) via the trailer control valve system, and/or controlling the brake valve (10) in such a way that it moves into a closed state and into the open state in an alternating fashion, whereby the pressure medium source (9) is emptied.

13. The method according to claim 12, further comprising:
outputting (800) a safety signal, which signals to the driver that the parking brake is now engaged when the pressure medium source (9) has been emptied such that pressure medium still stored in the pressure medium source (9) is not sufficient for disengaging the parking brake (24), and
stopping (900) the actuation of the service brake or secondary braking system.
